(19) United States
(12) Patent Application Publication
(10) Pub. No.: US 2010/0176199 A1
(43) Pub. Date: Jul. 15, 2010

(54) METHOD OF PROVIDING MULTIMEDIA NEWSPAPER

(76) Inventor: Kuo-Shen Liu, Taipei (TW)

Correspondence Address: LEONG C LEI, PMB # 1008, 1867 YGNACIO VALLEY ROAD, WALNUT CREEK, CA, 94598, US

(21) Appl. No.: 12/349,527

(22) Filed: Jan. 7, 2009

(51) Int. Cl. G06K 19/06; G06K 7/10

(52) U.S. Cl. 235/462.01; 235/494

(57) ABSTRACT

The newspaper provider stores a set of multimedia information about a specific news in a news web site. Then on the printed newspaper, a specific one-dimensional barcode identifying the corresponding set of multimedia information is printed alongside the specific news. When the newspaper reader is interested in learning more about the specific news, the reader uses a barcode reader connected to a computer to scan the one-dimensional barcode. The scanned barcode is sent to the news web site via Internet. The news web site uses the scanned barcode to locate and transmit the specific news' set of multimedia information to the computer where its text and video part is displayed on a display device and its audio part is played through a speaker.

### TECHNICAL FIELD OF THE INVENTION

The present invention generally relates to newspapers, and more particularly to a method of providing electronic multimedia news through Internet to accompany conventional newspaper.

### DESCRIPTION OF THE PRIOR ART

The conventional newspaper has already lost its edge to television news broadcast decades ago as the newspaper does not offer the more exciting audio and visual effects and its timeliness is also significantly inferior. The conventional newspaper is further challenged recently by the ubiquitous Internet and its on-line news. Additionally, the increasing paper pricing resulted from the depleting natural resources has made the position of the conventional newspaper even more difficult. However, the newspaper is not difficult replaced mainly due to that people's reading habit is hard to change.

### SUMMARY OF THE INVENTION

Therefore, a major purpose of the present invention is to provide a method to make the conventional newspaper more appealing by accompanying the paper-based news with electronic multimedia information through Internet.

According to the present invention, the newspaper provider stores a set of multimedia information about a specific news in a news web site. Then on the printed newspaper, a specific one-dimensional barcode identifying the corresponding set of multimedia information is printed alongside the specific news. When the newspaper reader is interested in learning more about the specific news, the reader uses a barcode reader connected to a computer to scan the one-dimensional barcode.

The scanned barcode is sent to the news web site via Internet. The news web site uses the scanned barcode to locate and transmit the specific news' set of multimedia information to the computer. Within the set of multimedia information, the text and video part is displayed on a display device and the audio part is played through a speaker, both connected to the computer.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing the various components of the environment where the present invention is implemented and how information flows among the various components.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

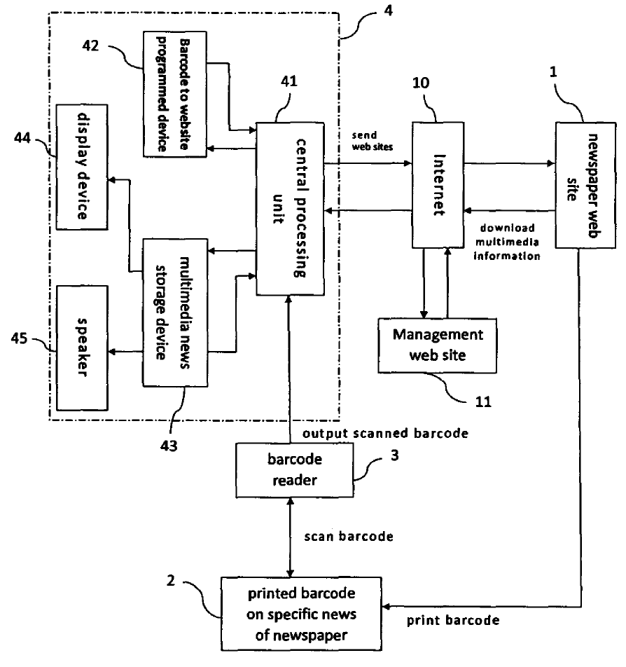

As shown in FIG. 1, the newspaper provider should have a newspaper web site 1 and the newspaper provider could store a set of multimedia information (audio recording, video recording, graphs, images, as well as text) about a specific news 2 in the news web site 1. The newspaper provider assigns a unique one-dimensional barcode corresponding to the specific news 2 by a management web site 11 via Internet 10. Then on the printed newspaper, a specific one-dimensional barcode is printed alongside the specific news 2. Please note that the newspaper provider could update the set of multimedia information any time before and after the newspaper is printed and delivered.

When the newspaper is in a reader's hand, the reader, if interested in learning more about the specific news 2, could use a barcode reader 3 connected to a computer 4 to scan the one-dimensional barcode. The computer 4, like all ordinary computers, has a central processing unit (CPU) 41, a Barcode to website programmed device 42 and a multimedia news storage 43, a display device 44, and a speaker 45. Please note that the computer 4 could be an independent personal computer or one that integrated into a television's set top box. Therefore, the display device 44 could be a screen of the personal computer or the television. In addition, the barcode reader 3 could be connected to the personal computer or the set top box through a wired or wireless connection.

When the barcode is scanned into the computer 4, it is checked to see if the corresponding set of multimedia information is already stored in the programmed device 42. If it is, the set of multimedia information is read into the multimedia news storage device 43. Within the set of multimedia information, the text, graph, image, and video part is displayed on the display device 44 and the audio part is played through the speaker 45. If the corresponding set of multimedia information is not yet stored in the storage device 43, the scanned barcode is sent to the newspaper web site 1 via Internet 10. The newspaper web site 1 uses the scanned barcode to locate and transmit the specific news' set of multimedia information to the computer 4. The computer 4 then stores the set of multimedia information in the storage device 43 and presents the set of multimedia information on the display device 44 and/or the speaker 45 as described. In this way, the set of multimedia information is not required to be downloaded each time the specific news' barcode is scanned. In other words, the news storage device 43 is used as a cache to cut down bandwidth usage.

However, since the set of multimedia information could be updated (but not frequently), the computer 4 could always check the news storage device 43 as described above until the set of multimedia information is downloaded, say, more than an hour. After that, if the computer 4 receives the same barcode, the computer 4 will send the barcode to the news web site 1 to retrieve the latest set of multimedia information. For some news that is frequently updated, a special kind of barcode could be used. For this special kind of barcode, the computer 4 will never check the news storage device 43 and will always download the set of multimedia information directly from the news web site 1.

As the space of the news storage device 43 is limited, the computer 4 could periodically delete the stored sets of multimedia information that are downloaded more than a predetermined period of time so as to save space.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method of providing multimedia newspaper, comprising the steps of:
printing a one-dimensional barcode alongside a specific news on a newspaper;
storing a set of multimedia information about said specific news in a news web site;
scanning said one-dimensional barcode on said newspaper by a barcode reader connected to a computer and sending said one-dimensional barcode to said news web site by said computer via Internet;
said news web site locating by said one-dimensional barcode and transmitting said set of multimedia information to said computer; and
said computer presenting said set of multimedia information via a display device and a speaker, both connected to said computer.

2. The method according to claim 1, wherein said computer is one of a personal computer and a television's set top box; and said display device is a screen of said computer or TV.

3. The method according to claim 1, wherein said barcode reader is connected to said computer or set top box through one of a wired connection and a wireless connection.
